(19) United States
(12) Patent Application Publication
(10) Pub. No.: US 2009/0232211 A1
(43) Pub. Date: Sep. 17, 2009

(54) METHOD AND APPARATUS FOR ENCODING/DECODING IMAGE BASED ON INTRA PREDICTION

(75) Inventors: Jianle CHEN, Suwon-si (KR); Bae-keun LEE, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/402,820

(22) Filed: Mar. 12, 2009

(30) Foreign Application Priority Data
Mar. 12, 2008 (KR) 10-2008-0022995

(51) Int. Cl. H04N 11/02

(52) U.S. Cl. 375/240.13; 375/240.25; 375/E07.211

(57) ABSTRACT

Provided is an intra prediction-based encoding method, and an apparatus for accomplishing the same. In the method, an order of scanning sub blocks divided from a current block is determined based on an edge present in the current block; a predicted block is generated by performing intra prediction on the current block in the order of scanning, based on already encoded blocks adjacent to the current block; and a residual block that is a difference between the current block and the predicted block is encoded. Accordingly, the precision of intra prediction can be improved, thus increasing the quality of an image.

### CROSS-REFERENCE TO RELATED PATENT APPLICATIONS

This application claims priority from Korean Patent Application No. 10-2008-0022995, filed on Mar. 12, 2008, in the Korean Intellectual Property Office, the disclosure of which is incorporated herein in its entirety by reference.

### BACKGROUND OF THE INVENTION

1. Field of the Invention

Methods and apparatuses consistent with the present invention relate to intra encoding/decoding an image.

2. Description of the Related Art

In video compression methods, such as MPEG (Moving Picture Experts Groups)-1, MPEG-2, and MPEG-4 H.264/MPEG-4 Advanced Video Coding (AVC), a picture is divided into a plurality of macro blocks in order to encode or decode the picture. Next, each of the macro blocks is encoded using inter prediction (temporal prediction) and intra prediction (spatial prediction). Next, an optimal encoding mode is selected in consideration of the data sizes of the encoded macro blocks and the extent of degradation of the original macro blocks, and the macro blocks are encoded according to the optimal coding mode.

In intra prediction, encoding is performed using pixels spatially adjacent to the current block within a current picture without using a reference picture. First, a predicted block of the current block that is to be encoded is generated using the values of the adjacent pixels, and only the difference between the pixel values of the predicted block and the current block is encoded. An intra prediction mode is largely classified into a 4×4 intra prediction mode, an 8×8 intra prediction mode, and a 16×16 intra prediction mode according to luminance components, and an intra prediction mode according to chrominance components.

### SUMMARY OF THE INVENTION

The present invention provides an intra prediction-based encoding method and apparatus capable of improving the quality of an image through efficient intra prediction, and a computer readable medium having recorded thereon a computer program for executing the above method.

The present invention also provides an intra prediction-based decoding method and apparatus capable of improving the quality of an image through efficient intra prediction, and a computer readable medium having recorded thereon a computer program for executing the above method.

According to an aspect of the present invention, there is provided an intra prediction-based encoding method including: determining an order of scanning sub blocks divided from a current block based on an edge present in the current block; generating a predicted block by performing intra prediction on the current block in the order of scanning, based on already encoded blocks adjacent to the current block; and encoding a residual block that is a difference between the current block and the predicted block.

According to another aspect of the present invention, there is provided a computer readable medium having recorded thereon a computer program for executing an intra prediction-based encoding method including: determining an order of scanning sub blocks divided from a current block based on an edge present in the current block; generating a predicted block by performing intra prediction on the current block in the order of scanning, based on already encoded blocks adjacent to the current block; and encoding a residual block that is a difference between the current block and the predicted block.

According to another aspect of the present invention, there is provided an intra prediction-based decoding method including: reconstructing a residual block that is a difference between a current block and a predicted block, and reconstructing information regarding an order of scanning a plurality of sub blocks included in the current block from a bitstream; generating the predicted block by performing intra prediction on the current block based on the information regarding the order of scanning, using already encoded blocks adjacent to the current block; and reconstructing the current block by combining the predicted block and the reconstructed residual block.

According to another aspect of the present invention, there is provided a computer readable medium having recorded thereon a computer program for executing an intra prediction-based decoding method including: reconstructing a residual block that is a difference between a current block and a predicted block, and reconstructing information regarding an order of scanning a plurality of sub blocks included in the current block from a bitstream; generating the predicted block by performing intra prediction on the current block based on the information regarding the order of scanning, using already encoded blocks adjacent to the current block; and reconstructing the current block by combining the predicted block and the reconstructed residual block.

According to another aspect of the present invention, there is provided an intra prediction-based encoding apparatus comprising: an intra prediction unit which generates a predicted block by determining an order of scanning sub blocks divided from a current block, based on an edge present in the current block, and by performing intra prediction on the current block in the order of scanning and using already encoded blocks adjacent to the current block; and an encoding unit which encodes a residual block that is a difference between the current block and the predicted block.

According to another aspect of the present invention, there is provided an intra prediction decoding apparatus including: a decoding unit which reconstructs a residual block that is a difference between a current block and a predicted block and which reconstructs information regarding order of scanning a plurality of sub blocks included in the current block, from a bitstream; an intra prediction unit which generates the predicted block by performing intra prediction on the current block based on the information regarding the order of scanning, using already encoded blocks adjacent to the current block; and an adder which reconstructs the current bock by combining the predicted block and the reconstructed residual block.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an image encoding apparatus including an intra prediction-based encoding apparatus, according to an exemplary embodiment of the present invention;

FIG. 2 illustrates a general order of scanning a macro block;

FIG. 3 is a block diagram illustrating in detail an intra prediction unit illustrated in FIG. 1;

FIG. 4A is a diagram illustrating examples of a case where an edge is present in a vertical direction;

FIG. 4B is a diagram illustrating examples of a case where an edge is present in a horizontal direction;

FIG. 5A is a diagram illustrating an example of the order of scanning, which is determined by a scan order determining unit of FIG. 3 when an edge is present in the vertical direction;

FIG. 5B is a diagram illustrating an example of the order of scanning, which is determined by a scan order determining unit of FIG. 3, when an edge is present in a horizontal direction;

FIG. 6A illustrates an example of the result after performing intra prediction according to a conventional order of scanning, when an edge is present in a horizontal direction;

FIG. 6B illustrates an example of the result after performing intra prediction according to the order of adaptive scanning, when an edge is present in a horizontal direction, according to an exemplary embodiment of the present invention;

FIG. 7A illustrates an example of the result after performing intra prediction according to a conventional order of scanning, when an edge is present in both horizontal and vertical directions;

FIG. 7B illustrates an example of the result after performing intra prediction according to the order of adaptive scanning, when an edge is present in both horizontal and vertical directions, according to an exemplary embodiment of the present invention;

FIG. 8 is a diagram illustrating an example of the order of scanning, determined by a scan order determining unit of FIG. 3;

FIGS. 9A and 9B are diagrams illustrating an operation of a prediction performing unit of FIG. 3 with respect to the current block of FIG. 8, according to an exemplary embodiment of the present invention;

FIG. 10 is a block diagram of an image decoding apparatus including an intra prediction-based decoding apparatus, according to an exemplary embodiment of the present invention;

FIG. 11 is a block diagram illustrating in detail an intra prediction unit of FIG. 10, according to an exemplary embodiment of the present invention;

FIG. 12 is a flowchart illustrating an intra prediction-based encoding method, according to an exemplary embodiment of the present invention; and

FIG. 13 is a flowchart illustrating an intra prediction-based decoding method, according to an exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings. Like reference numerals denote like elements throughout the drawings.

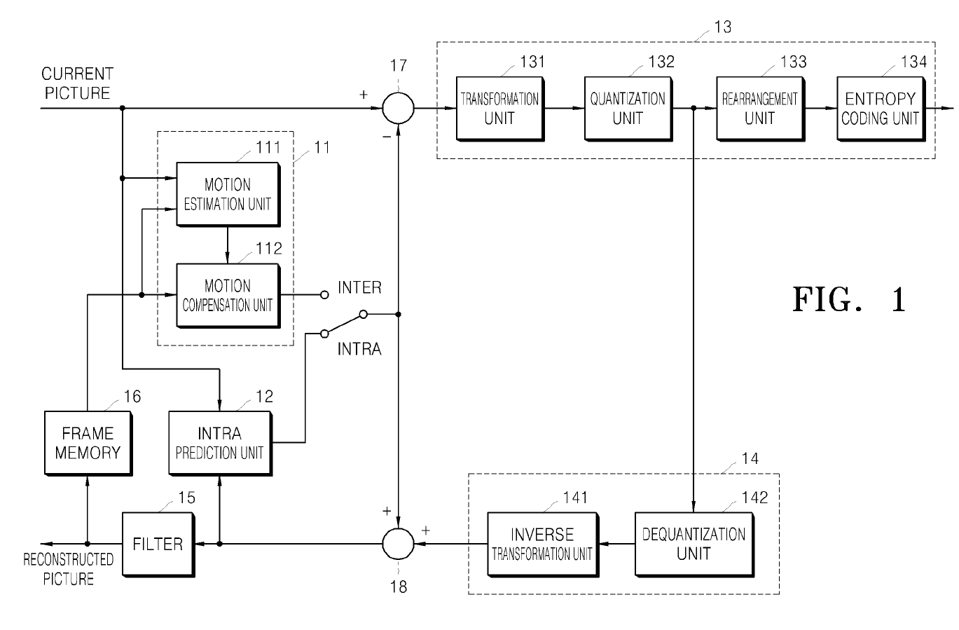

FIG. 1 is a block diagram of an image encoding apparatus including an intra prediction-based encoding apparatus, according to an exemplary embodiment of the present invention. An intra prediction-based encoding apparatus according to an exemplary embodiment of the present invention will now be described by applying it to an image encoding apparatus according to the H.264 standard. However, it would be apparent to those of ordinary skill in the art that an intra prediction-based encoding apparatus according to an exemplary embodiment of the present invention can be applied to intra prediction-based image encoding according to various other standards.

Referring to FIG. 1, the image encoding apparatus includes an inter prediction unit 11, an intra prediction unit 12, an encoding unit 13, and a reconstructing unit 14. The image encoding apparatus may further include a filter 15, a frame memory 16, a subtracter 17, and an adder 18. Here, the intra prediction unit 12 and the encoding unit 13 correspond to an intra prediction-based encoding apparatus.

The inter prediction unit 11 includes a motion estimation unit 111 and a motion compensation unit 112. The inter prediction unit 11 performs inter prediction by searching a reference picture stored in the frame memory 16 for a predicted value of a macro block included in a current picture.

The intra prediction unit 12 performs intra prediction in which a predicted value of a current block is searched for from an adjacent block in the current picture. More specifically, the intra prediction unit 12 detects a previously encoded region in the current picture according to the order of scanning the current block in units of pixels by using pixels adjacent to the current block, and predicts the current block based on the result of detecting. Here, the pixels may be 4×4 pixels, 8×8 pixels, or 16×16 pixels.

The subtracter 17 generates a residual block by subtracting a predicted block, which is predicted from the current block, from the current block. More specifically, in the case of an inter mode, the subtracter 17 receives a predicted block from the inter prediction unit 11 and subtracts it from the current block. In the case of an intra mode, the subtracter 17 receives a predicted block from the intra prediction unit 12 and subtracts it from the current block.

The encoding unit 13 includes a transformation unit 131, a quantization unit 132, a rearrangement unit 133, and an entropy coding unit 134. The encoding unit 13 encodes the residual block received from the subtracter 17, inserts the result of encoding into a bitstream and then outputs the bitstream.

The reconstruction unit 14 includes an inverse transformation unit 141 and a dequantization unit 142, and reconstructs the residual block by dequantizing and inversely transforming the result of quantizing received from the quantization unit 132.

The adder 18 combines the residual block reconstructed by the reconstruction unit 14 and the predicted block received from the inter prediction unit 11 or the intra prediction unit 12, and outputs the result of combining as a reconstructed current block. The reconstructed current block is stored in the frame memory 16 via the filter 15. Such a value stored in the frame memory 16 is used when the inter prediction unit 11 performs inter prediction or the intra prediction unit 12 performs intra prediction.

FIG. 2 illustrates a general order of scanning a macro block. Referring to FIG. 2, the macro block consists of 16×16 pixels. The macro block may be four sub blocks a1, a2, a3, and a4 each consisting of 8×8 pixels. Also, the macro block may be divided into sixteen sub blocks each consisting of 4×4 pixels. When intra prediction is performed in units of 8×8 pixels, intra prediction is performed in the order from the left upper sub block a1, the right upper sub block a2, the left lower sub block a3, and the right lower sub block a4. Likewise, when intra prediction is performed in units of 4×4 pixels, intra prediction is performed in the order from the left upper sub block a1, the right upper sub block a2, the left lower sub block a3, and the right lower sub block a4. Thus, in this case, intra prediction is performed in the order of scanning indexed in FIG. 2, that is, in the order from 0 to 15.

Hereinafter, for convenience of explanation, it is assumed that a current bock is a 16×16 pixel block and a sub block is an 8×8 or 4×4 pixel block. However, it would be apparent to those of ordinary skill in the art that a current block may be a 4×4 pixel block. Also, it is assumed that a basic unit in which intra prediction is performed is a 4×4 pixel block. However, it would be apparent to those of ordinary skill in the art that the forthcoming description can also be applied to intra prediction performed in units of 8×8 pixels or 16×16 pixels.

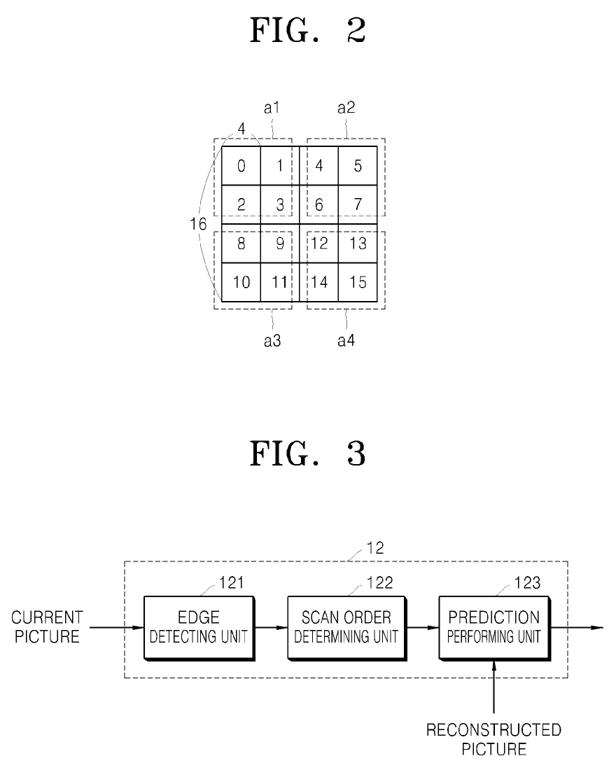

FIG. 3 is a block diagram illustrating in detail the intra prediction unit 12 illustrated in FIG. 1. Referring to FIG. 3, the intra prediction unit 12 includes an edge detecting unit 121, a scan order determining unit 122, and a prediction performing unit 123.

The edge detecting unit 121 detects an edge in a current block from among a plurality of blocks present in a received current picture. Here, the edge means a line present in an object, and the boundary of an object is a type of an edge of the object. For example, if an object is a building, an edge may be not only the boundary of the object but also a line expressing the frame of a window present in the building.

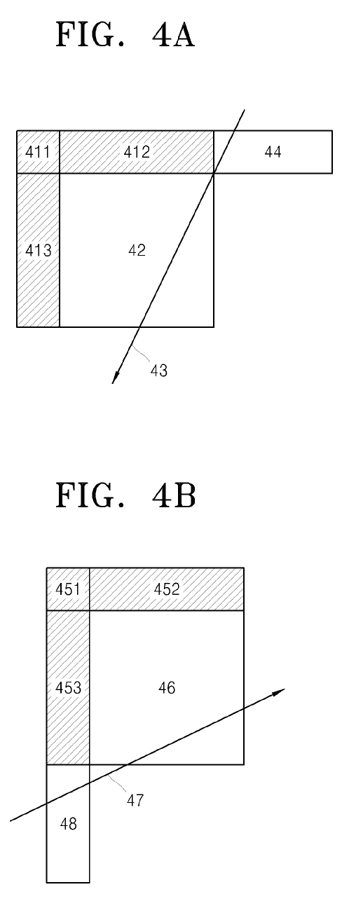

Also, the edge detecting unit 121 determines whether the detected edge is present in a vertical direction or a horizontal direction, that is, it detects the directionality of the edge. Here, the vertical direction may mean that the angle of the edge is 45 or more degrees, and the horizontal direction may mean that the angle of the edge is 45 or less degrees. The operation of the edge detecting unit 121 will be described later with reference to FIGS. 4A and 4B.

FIG. 4A is a diagram illustrating examples of a case where an edge is present in a vertical direction. Referring to FIGS. 2, 3 and 4A, shaded blocks 411 through 413 denote already encoded first through third neighboring blocks, a white block 42 denotes a current block, and a solid-line arrow 43 denotes an edge. Hereinafter, for convenience of explanation, it is assumed that the current block 42 corresponds to the block with index number ‘3’ illustrated in FIG. 2. Also, it is assumed that the first neighboring block 411 corresponds to the block with index number ‘0’ in FIG. 2, the second neighboring block 412 corresponds to the block with index number ‘1’ in FIG. 2, and the third neighboring block 413 denotes the block with index number ‘2’ in FIG. 2.

In this case, since the edge 43 detected by the edge detecting unit 121 is present in a vertical down-left direction, when intra prediction is performed on the current block 42, the efficiency of intra prediction can be improved by referring to a fourth neighboring block 44 rather than the first through third neighboring blocks 411, 412, and 413. However, when intra prediction is performed in the order of scanning according to the index numbers in FIG. 2, intra prediction is performed on the fourth neighboring block 44 after completing performing intra prediction on the current block 42, thereby preventing intra prediction from being efficiently performed based on the directionality of edge.

FIG. 4B is a diagram illustrating examples of a case where an edge is present in a horizontal direction. Referring to FIGS. 2, 3 and 4B, shaded blocks 451 through 453 denote already encoded fifth through seventh neighboring blocks, a white block 46 denotes a current block, and a solid-line arrow 47 denotes an edge. Hereinafter, for convenience of explanation, it is assumed that the current block 46 corresponds to the block with index number ‘3’ illustrated in FIG. 2. Also, it is assumed that the fifth neighboring block 451 corresponds to the block with index number ‘0’ in FIG. 2, the sixth neighboring block 452 corresponds to the block with index number ‘1’ in FIG. 2, and the seventh neighboring block 453 denotes the block with index number ‘2’ in FIG. 2.

In this case, since the edge 47 detected by the edge detecting unit 121 is present in a horizontal up-right direction, when intra prediction is performed on the current block 46, the efficiency of intra prediction can be improved by referring to an eighth neighboring block 48 rather than the fifth through seventh neighboring blocks 451, 452, and 453. However, when intra prediction is performed in the order of scanning according to the index numbers in FIG. 2, intra prediction is performed on the eighth neighboring block 48 after completing performing intra prediction on the current block 46, thereby preventing intra prediction from being efficiently performed based on the directionality of edge.

Referring to FIG. 3, the scan order determining unit 122 adaptively determines the order of scanning a current block based on the edge detected by the edge detecting unit 121.

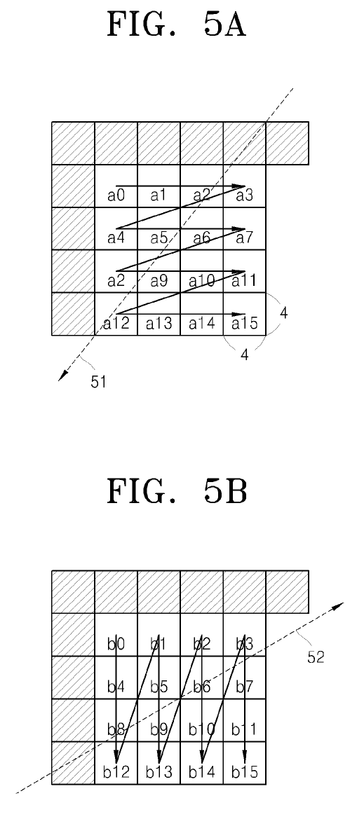

More specifically, the scan order determining unit 122 adaptively determines the order of scanning a current block according to the directionality of the edge detected by the edge detecting unit 121. That is, if the edge is present in the vertical direction, the scan order determining unit 122 may determine scanning to be performed in the horizontal direction, and if the edge is present in the horizontal direction, the scan order determining unit 122 may determine scanning to be performed in the vertical direction (see FIGS. 5A and 5B for details).

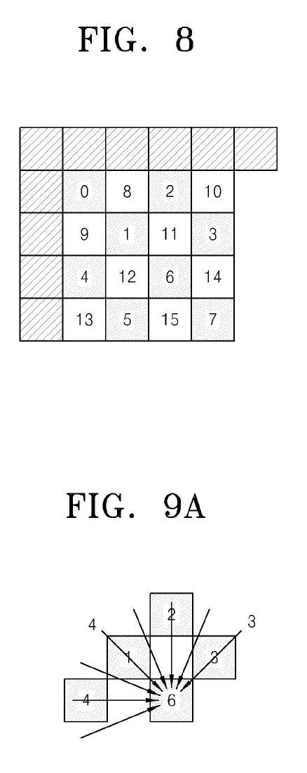

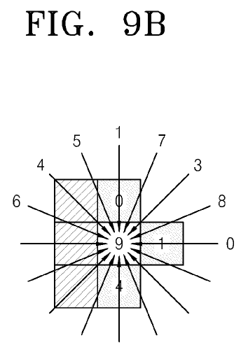

Also, the scan order determining unit 122 may determine the current block to be scanned in the order of sequentially scanning or the order of interlaced scanning, which will be described later with reference to FIGS. 8, 9A and 9B.

The prediction performing unit 123 performs intra prediction on the current block according to a predetermined prediction mode and in the order of scanning, which is adaptively determined by the scan order determining unit 122. In detail, if the order of scanning is the order of the horizontal direction, the prediction performing unit 123 may perform intra prediction using upper right pixels. If the order of scanning is the order of the vertical direction, the prediction performing unit 123 may perform intra prediction using lower left pixels. According to the H.264 standards, for video encoding, a current block is encoded according to a total of thirteen modes of the 4×4 intra prediction mode and the 16×16 intra prediction mode, and a bitstream for the current block is generated according to an optimal mode from among the thirteen modes.

The 16×16 intra prediction mode for performing intra prediction on a 16×16 pixel is classified into a total of four prediction modes: a vertical mode (0), a horizontal mode (1), a DC (direct current) mode (2), and a plane mode (3). The prediction mode number indexed to each of the above prediction modes is determined by the frequency of using the prediction mode. In other words, the vertical mode with prediction mode number ‘0’ is most frequently used and the plane mode with prediction mode number ‘3’ is least frequently used, when intra prediction is performed.

The 4×4 intra prediction mode for performing intra prediction on a 4×4 pixel is classified into a total of nine prediction modes: a vertical mode (0), a horizontal mode (1), a DC mode (2), a diagonal down-left mode (3), a diagonal down-right mode (4), a vertical right mode (5), a vertical left mode (6), a horizontal-up mode (7), and a horizontal-down mode (8).

FIG. 5A is a diagram illustrating an example of the order of scanning, which is determined by the scan order determining unit 122 of FIG. 3 when an edge is present in the vertical direction. Referring to FIGS. 2, 3 and 5A, a current block includes sixteen white sub blocks a0, a1, a2, . . . , and a15. Here, shaded blocks denote already encoded neighboring blocks adjacent to the current block, and an edge 51 is present in the current block in a vertical down-left direction.

When intra prediction is performed in the order of scanning according to the index numbers in FIG. 2, the sub block a5 is intra predicted prior to intra predicting of the sub block a2. However, in this case, since the edge 51 is present in the vertical down-left direction, a predicted value can be precisely obtained by first intra predicting the sub block a2, and then intra predicting the sub block a5 based on the result of the first intra prediction.

Accordingly, according to the current exemplary embodiment, the scan order determining unit 122 determines the order of scanning sub blocks included in a current block to be the horizontal direction as indicated with solid-line arrows illustrated in 5A. In other words, the scan order determining unit 122 determines the order of scanning in such a manner that the current block is scanned in the order of sub blocks a0, a1, a2, a3, a4, a5, a6, a7, a8, a9, a10, a11, a12, a13, a14, and a15. Thus, the sub block a5 can be intra predicted using a predicted value of the sub block a2 that has already been intra predicted, thereby improving the precision and efficiency of intra prediction.

FIG. 5B is a diagram illustrating an example of the order of scanning, which is determined by the scan order determining unit 122 of FIG. 3, when an edge is present in the horizontal direction. Referring to FIGS. 2, 3 and 5B, a current block includes sixteen white sub blocks b0, b1, b2, . . . , and b15. Here, shaded blocks denote already encoded neighboring blocks adjacent to the current block, and an edge 52 is present in the current block in a horizontal up-right direction.

When intra prediction is performed in the order of scanning according to the index numbers in FIG. 2, the sub block b6 is intra predicted prior to intra predicting of the sub blocks b8, b9 and b12. However, in this case, since the edge 52 is present in the horizontal up-right direction, a predicted value can be precisely obtained by first intra predicting the sub blocks b8, b9 and b12, and then intra predicting the sub block b6 based on the result of the first intra prediction.

Accordingly, according to the current exemplary embodiment, the scan order determining unit 122 determines the order of scanning sub blocks included in a current block to be the horizontal direction as indicated with solid-line arrows illustrated in 5B. In other words, the scan order determining unit 122 determines the order of scanning in such a manner that the current block is scanned in the order of sub blocks b0, b1, b2, b3, b4, b5, b6, b7, b8, b9, b10, b11, b12, b13, b14, and b15. Thus, the sub block b6 can be intra predicted using predicted values of the sub blocks b8, b9 and b12 that have already been intra predicted, thereby improving the precision and efficiency of intra prediction.

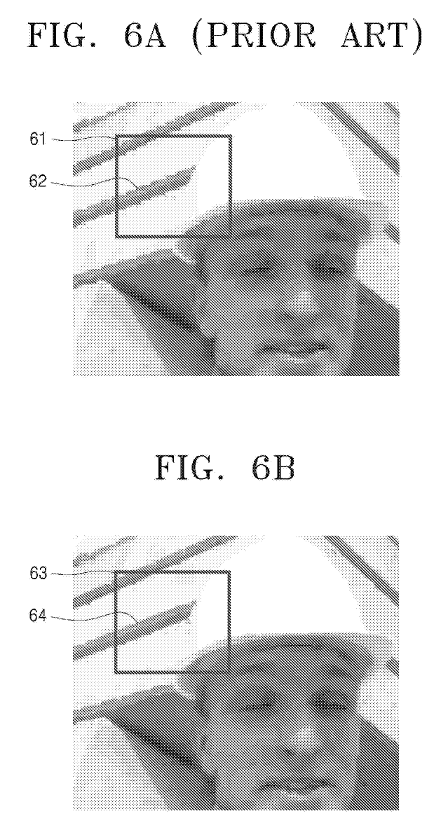

FIG. 6A illustrates an example of the result after performing intra prediction according to a conventional order of scanning, when an edge is present in the horizontal direction. FIG. 6B illustrates an example of the result after performing intra prediction according to the order of adaptive scanning, when an edge is present in the horizontal direction, according to an exemplary embodiment of the present invention.

Referring to FIG. 6A, serious block distortion is produced when intra prediction is performed according to a conventional order of scanning, regardless of the directionality of an edge present in a current block 61. However, referring to FIG. 6B, in the current exemplary embodiment, when an edge 64 is present in a current block 63 in the horizontal direction, intra prediction is performed in the order of vertical scanning. Thereby, the quality of image can be improved since block distortion can be reduced more greatly than in the prior art.

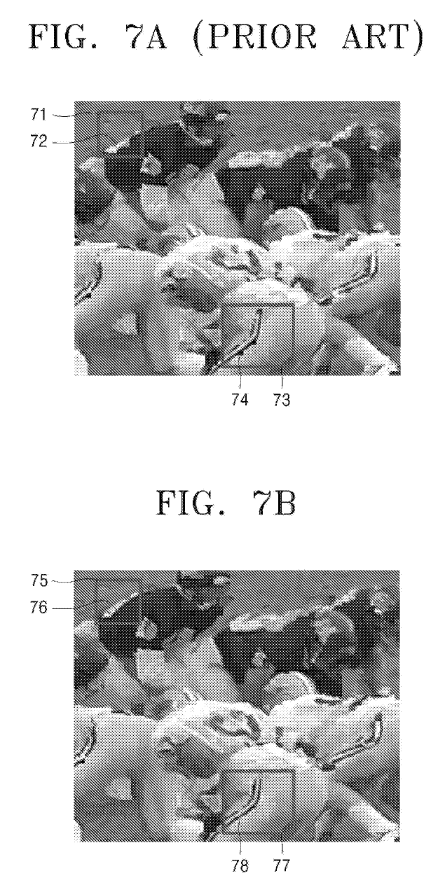

FIG. 7A illustrates an example of the result after performing intra prediction according to a conventional order of scanning, when an edge is present in both horizontal and vertical directions. FIG. 7B illustrates an example of the result after performing intra prediction according to the order of adaptive scanning, when an edge is present in both horizontal and vertical directions, according to an exemplary embodiment of the present invention.

Referring to FIG. 7A, when a first edge 72 is present in a first current block 71 in the horizontal direction and a second edge 74 is present in a second current block 73 in the vertical direction, serious block distortion is produced if intra prediction is performed according to a conventional order of scanning regardless of the directionalities of the edges 72 and 74. However, referring to FIG. 6B, in the current exemplary embodiment, when a first edge 76 is present in a first current block 75 in the horizontal direction, intra prediction is performed in the order of vertical scanning, and when a second edge 78 is present in a second current block 77 in the horizontal direction, intra prediction is performed in the order of horizontal scanning. Thereby, the quality of image can be improved since block distortion can be reduced more greatly than in the prior art.

FIG. 8 is a diagram illustrating an example of the order of scanning, determined by the scan order determining unit 122 of FIG. 3. Referring to FIGS. 3 and 8, according to the current exemplary embodiment, the scan order determining unit 122 may adaptively determine the order of scanning a current block to be at least one of the order of sequential scanning and the order of interlaced scanning. Here, the order of sequential scanning means that scanning is continuously performed with respect to neighboring blocks as illustrated in FIGS. 2, 5A and 5B.

The order of interlaced scanning means that some of sub blocks are scanned in a first operation and the other sub blocks are scanned in a second operation. In this case, the order of scanning in each of the first and second operations may be the conventional order of scanning as illustrated in FIG. 2, the order of horizontal scanning as illustrated in FIG. 5A, or the order of vertical scanning as illustrated in FIG. 5B. However, hereinafter, for convenience of explanation, it is assumed the order of scanning is the conventional order of scanning as illustrated in FIG. 2.

In FIG. 8, shaded blocks denote already encoded neighboring blocks adjacent to a current block, grey blocks denote blocks that are to be inter predicted in the first operation, and white blocks denote blocks that are to be inter predicted in the second operation. Thus, as indexed in FIG. 8, blocks with index numbers ‘0’ through ‘7’ are sequentially intra predicted in the first operation, and blocks with index numbers ‘8’ through ‘15’ are sequentially intra predicted in the second operation.

FIGS. 9A and 9B are diagrams illustrating the operation of the prediction performing unit 123 of FIG. 3 with respect to the current block of FIG. 8, according to an exemplary embodiment of the present invention. Referring to FIGS. 3, 8 and 9A, the prediction performing unit 123 performs intra prediction on the grey blocks illustrated in FIG. 8 in a first operation. The sub block with index number ‘6’ is intra predicted using predicted values of the sub blocks with index numbers ‘1’ through ‘4’ that have already been intra predicted. Here, reference numerals indicated beside solid-line arrows denote prediction modes.

Referring to FIGS. 3, 8 and 9B, the prediction performing unit 123 performs intra prediction on the grey blocks illustrated in FIG. 8 in a second operation. The sub block with index number ‘9’ can be intra predicted bi-directionally, based on predicted values of the sub blocks with index numbers ‘0’, ‘1’, and ‘4’ that were intra predicted in the first operation and predicted values the shaded sub blocks that have previously been encoded. In detail, according to the prediction mode 1, intra prediction can be performed not only using the sub block with index number ‘0’ but also the sub block with index number ‘4’, thereby increasing the precision of intra prediction.

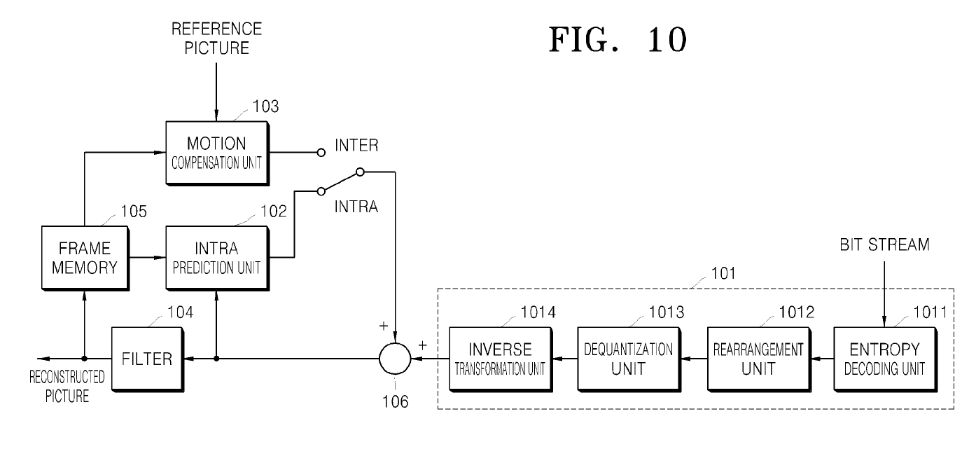

FIG. 10 is a block diagram of an image decoding apparatus including an intra prediction-based decoding apparatus, according to an exemplary embodiment of the present invention. Referring to FIG. 10, the image decoding apparatus includes a decoding unit 101, an intra prediction unit 102, a motion compensation unit 103, a filter 104, a frame memory 105, and an adder 106. Here, the decoding unit 101 and the intra prediction unit 102 correspond to an intra prediction-based decoding apparatus according to an exemplary embodiment of the present invention.

The decoding unit 101 includes an entropy decoding unit 1011, a rearrangement unit 1012, a dequantization unit 1013, and an inverse transformation unit 1014. The decoding unit 101 reconstructs a residual block that is the difference between a current block and a predicted block by decoding a received bitstream. The decoding unit 101 also reconstructs information regarding the order of scanning, used when the current block is intra predicted. In addition, the decoding unit 101 can reconstruct transformation encoding coefficients, motion vector information, header information, etc.

The motion compensation unit 103 performs motion compensation based on a reconstructed picture stored in the frame memory 105, and uses a predicted value obtained by performing motion compensation as a predicted block for the current block.

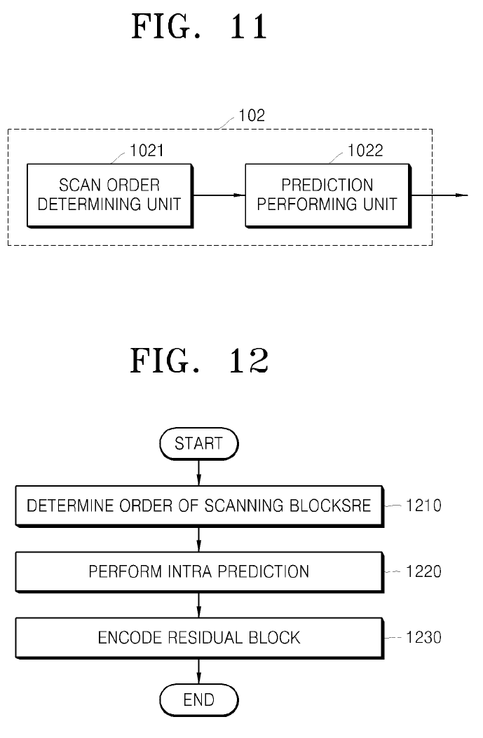

The intra prediction unit 102 performs intra prediction on the current block, based on the reconstructed picture stored in the frame memory 105 and the information regarding the order of scanning, which is reconstructed by the decoding unit 101. The operation of the intra prediction unit 102 will be described in detail later with reference to FIG. 11.

The adder 106 reconstructs the current block by combining a predicted block received from the motion compensation unit 103 or the intra prediction unit 102 and the residual block reconstructed by the decoding unit 101. The reconstructed current block is stored in the frame memory 105 via the filter 104.

FIG. 11 is a block diagram illustrating in detail the intra prediction unit 102 of FIG. 10, according to an exemplary embodiment of the present invention. Referring to FIGS. 10 and 11, the intra prediction unit 102 includes a scan order determining unit 1021 and a prediction performing unit 1022.

The scan order determining unit 1021 determines the order of scanning a current block based on information regarding the order of scanning, which is reconstructed by the decoding unit 101. However, the scan order determining unit 1021 may determine the order of scanning by detecting an edge from the current block without referring to the information regarding the order of scanning.

The prediction performing unit 1022 generates a predicted block by intra predicting the current block according to a prediction mode and in the order of scanning determined by the scan order determining unit 1021. As described above, there are a total of thirteen prediction modes of the 4×4 intra prediction mode and the 16×16 intra prediction mode.

FIG. 12 is a flowchart illustrating an intra prediction-based encoding method, according to an exemplary embodiment of the present invention. Referring to FIG. 12, the intra prediction-based encoding method includes operations to be sequentially performed by the intra prediction-based encoding apparatus illustrated in FIG. 1. Thus, although not described here, the above description of the intra prediction-based encoding apparatus of FIG. 1 can also be applied to the intra prediction-based encoding method of FIG. 12.

Referring to FIGS. 1, 3 and 12, in operation 1210, the scan order determining unit 1021 adaptively determines the order of scanning a plurality of sub blocks included in a current block.

In operation 1220, the prediction performing unit 1022 generates a predicted block by performing intra prediction on the current block according to the determined order of scanning.

In operation 1230, the encoding unit 13 encodes a residual block that is the difference between the current block and the predicted block.

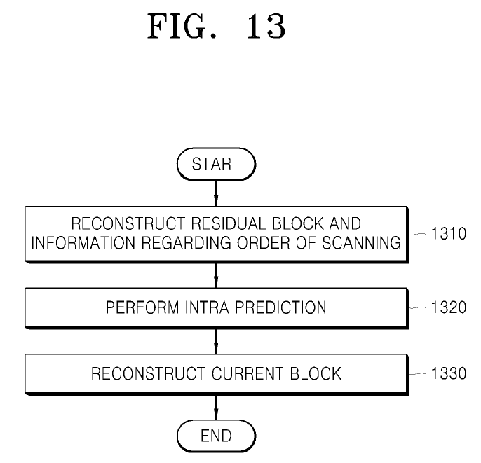

FIG. 13 is a flowchart illustrating an intra prediction-based decoding method, according to an exemplary embodiment of the present invention. Referring to FIG. 13, the intra prediction-based decoding method includes operations to be sequentially performed by the intra prediction-based decoding apparatus of FIG. 10. Thus, although not described here, the above description of the intra prediction-based decoding apparatus of FIG. 10 can also be applied to the intra prediction-based decoding method of FIG. 13.

In operation 1310, the decoding unit 101 reconstructs a residual block and information regarding the order of scanning from a bitstream.

In operation 1320, the intra prediction unit 102 generates a predicted block by performing intra prediction on the current block based on the information regarding the order of scanning.

In operation 1330, the adder 106 reconstructs the current block by combining the predicted block and the reconstructed residual block.

The system according to the present invention can be embodied as computer readable code in a computer readable storage medium. Here, the computer readable storage medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Additionally, the present invention may be embodied in a computer readable transmission medium. The computer readable transmission mediummay be a carrier wave that transmits data via the Internet, for example. The computer readable storage medium and computer readable transmission medium can be distributed among computer systems that are interconnected through a network, and the present invention may be stored and implemented as computer readable code in the distributed system.

According to the above exemplary embodiments of the present invention, the precision of intra prediction can be improved by adaptively determining the order of scanning a plurality of sub blocks divided from a current block, based on an edge present in the current block, and by efficiently performing intra prediction on the current block in the order of scanning, thereby improving the quality of image.

While this invention has been particularly shown and described with reference to exemplary embodiments thereof, it will be understood by those of ordinary skill in the art that various changes in form and details may be made therein without departing from the spirit and scope of the invention as defined by the appended claims.

What is claimed is:

1. An intra prediction-based encoding method comprising:
determining an order of scanning sub blocks divided from a current block based on an edge present in the current block;
generating a predicted block by performing intra prediction on the current block in the order of scanning, based on already encoded blocks adjacent to the current block; and
encoding a residual block that is a difference between the current block and the predicted block.

2. The method of claim 1, wherein the determining of the order of scanning comprises:
checking directionality of the edge by detecting the edge from the current block; and
adaptively determining the order of scanning the sub blocks based on the result of checking.

3. The method of claim 2, wherein the determining of the order of scanning comprises:
if the result of checking reveals that the edge is present in the vertical direction, determining the order of scanning the sub blocks to be an order of horizontal direction; and
if the result of checking reveals that the edge is present in the horizontal direction, determining the order of scanning the sub blocks to be an order of vertical direction.

4. The method of claim 3, wherein the generating of the predicted block comprises:
if the order of scanning is determined as the order of horizontal direction, performing intra prediction based on at least one pixel of a left block, a left upper block, an upper block, and a right upper block of the sub blocks; and
if the order of scanning is determined as the order of vertical direction, performing intra prediction based on at least one pixel of the left block, the left upper block, the upper block, the right upper block, and a left lower block of the sub blocks.

5. The method of claim 1, wherein the determining of the order of scanning comprises determining the order of scanning to be an order of sequential scanning or an order of interlaced scanning, based on the edge.

6. The method of claim 5, wherein the generating of the predicted block comprises:
if the order of scanning is determined to be the order of interlaced scanning, performing intra prediction on a first group of the sub blocks based on the already encoded blocks adjacent to the current block; and
performing intra prediction on a second group of sub blocks, based on the already encoded blocks adjacent to the current block and the intra predicted first group of sub blocks.

7. The method of claim 6, wherein the performing intra prediction of the second group of sub blocks comprises performing intra prediction based on at least one pixel of a left block, a left upper block, an upper block, a right upper block, a right block, a left lower block, and a lower block of each sub block in the second group of sub blocks.

8. The method of claim 1, wherein the current block is a 16×16 block, and the sub blocks are 4×4 or 8×8 blocks.

9. A computer readable storage medium having recorded thereon a computer program for executing an intra prediction-based encoding method, the method comprising:
determining an order of scanning sub blocks divided from a current block based on an edge present in the current block;
generating a predicted block by performing intra prediction on the current block in the order of scanning, based on already encoded blocks adjacent to the current block; and
encoding a residual block that is a difference between the current block and the predicted block.

10. An intra prediction-based decoding method comprising:
reconstructing a residual block that is a difference between a current block and a predicted block, and reconstructing information regarding an order of scanning a plurality of sub blocks included in the current block from a bitstream;
generating the predicted block by performing intra prediction on the current block based on the information regarding the order of scanning, using already encoded blocks adjacent to the current block; and
reconstructing the current block by combining the predicted block and the reconstructed residual block.

11. The method of claim 10, wherein the information regarding the order of scanning is determined by a directionality of an edge present in the current block.

12. The method of claim 11, wherein the generating of the predicted block comprises:
if the order of scanning is determined as an order of horizontal direction, performing intra prediction based on at least one pixel of a left block, a left upper block, an upper block, and a right upper block of the sub blocks; and
if the order of scanning is determined as an order of vertical direction, performing intra prediction based on at least one pixel of the left block, the left upper block, the upper block, the right upper block, and a left lower block of the sub blocks.

13. The method of claim 10, wherein the order of scanning is determined to be an order of sequential scanning or an order of interlaced scanning, based on the information regarding order of scanning, and
the generating of the predicted block comprises:
if the order of scanning is determined to be the order of interlaced scanning, performing intra prediction on a first group of the sub blocks based on the already encoded blocks adjacent to the current block; and
performing intra prediction on a second group of sub blocks, based on the already encoded blocks adjacent to the current block and the intra predicted first group of sub blocks.

14. The method of claim 13, wherein the performing intra prediction of the second group of sub blocks comprises performing intra prediction based on at least one pixel of a left block, a left upper block, an upper block, a right upper block, a right block, a left lower block, and a lower block of each sub block in the second group of sub blocks.

15. The method of claim 10, wherein the current block is a 16×16 block, and the sub blocks are 4×4 or 8×8 blocks.

16. A computer readable storage medium having recorded thereon a computer program for executing an intra prediction-based decoding method, the method comprising:
reconstructing a residual block that is a difference between a current block and a predicted block, and reconstructing information regarding an order of scanning a plurality of sub blocks included in the current block from a bitstream;
generating the predicted block by performing intra prediction on the current block based on the information regarding the order of scanning, using already encoded blocks adjacent to the current block; and
reconstructing the current block by combining the predicted block and the reconstructed residual block.

17. An intra prediction-based encoding apparatus comprising:
an intra prediction unit which generates a predicted block by determining an order of scanning sub blocks divided from a current block, based on an edge present in the current block, and by performing intra prediction on the current block in the order of scanning and using already encoded blocks adjacent to the current block; and
an encoding unit which encodes a residual block that is a difference between the current block and the predicted block.

18. The apparatus of claim 17, wherein the intra prediction unit comprises:
an edge detecting unit which detects the edge from the current block;
a scan order determining unit which adaptively determines the order of scanning the sub blocks based on the detected edge; and
a prediction performing unit which generates the predicted block by performing intra prediction on the current block in the order of scanning and based on the already encoded blocks adjacent to the current block.

19. An intra prediction decoding apparatus comprising:
a decoding unit which reconstructs a residual block that is a difference between a current block and a predicted block, and which reconstructs information regarding an order of scanning a plurality of sub blocks included in the current block, from a bitstream;
an intra prediction unit which generates the predicted block by performing intra prediction on the current block based on the information regarding the order of scanning, using already encoded blocks adjacent to the current block; and
an adder which reconstructs the current bock by combining the predicted block and the reconstructed residual block.

20. The apparatus of claim 19, wherein the intra prediction unit comprises:
a scan order determining unit which determines the order of scanning the sub blocks based on the reconstructed information regarding the order of scanning; and
a prediction performing unit which generates the predicted block by performing intra prediction on the current block in the order of scanning and using the already encoded blocks adjacent to the current block.
